(19) United States
(12) Patent Application Publication
(10) Pub. No.: US 2016/0112801 A1
(43) Pub. Date: Apr. 21, 2016

(54) MICROPHONE AND METHOD OF MANUFACTURING THE SAME

(71) Applicant: Hyundai Motor Company, Seoul (KR)

(72) Inventor: Ilseon Yoo, Seoul (KR)

(21) Appl. No.: 14/852,572

(22) Filed: Sep. 13, 2015

(30) Foreign Application Priority Data
Oct. 17, 2014 (KR) 10-2014-0141159

(51) Int. Cl. H04R 7/10; H04R 19/00; H04R 31/00; H04R 19/04

(52) U.S. Cl. CPC H04R 7/10; H04R 19/04; H04R 19/005; H04R 31/00; H04R 2201/003

(57) ABSTRACT

A microphone and a method of manufacturing thereof are provided. The microphon includes a substrate that includes a penetration aperture, a vibration membrane disposed over the substrate and covering the penetration aperture, and a fixed electrode disposed over the vibration membrane, separated from the vibration membrane, and including a plurality of air inlets. The vibration membrane includes a first sub-vibration membrane disposed over the substrate and covering the penetration aperture and includes a plurality of first slots and a second sub-vibration membrane disposed over the first sub-vibration membrane, connected to the first sub-vibration membrane, and including a connection unit and a plurality of second slots. The first sub-vibration membrane is flexible, and the second sub-vibration membrane is rigid.

### CROSS-REFERENCE TO RELATED APPLICATION

This application claims priority to and the benefit of Korean Patent Application No. 10-2014-0141159 filed in the Korean Intellectual Property Office on Oct. 17, 2014, the entire contents of which are incorporated herein by reference.

### BACKGROUND

(a) Technical Field

The present invention relates to a microphone and a method of manufacturing the microphone.

(b) Description of the Related Art

Generally, a microphone converts an input voice into an electrical signal, and has been recently gradually downsized. Accordingly, a microphone using a Micro Electro Mechanical System (MEMS) technology is being developed. A MEMS microphone is advantageous since the MEMS microphone has increased resistant to humidity and heat compared to a conventional Electret Condenser Microphone (ECM). Furthermore, the MEMS microphone may be downsized and integrated with a signal processing circuit.

Typically, the MEMS microphone is divided into a capacitance MEMS microphone and a piezoelectric MEMS microphone. The capacitance MEMS microphone includes a fixed electrode and a vibration membrane. When the vibration membrane has an external sound pressure applied thereto the distance between the fixed electrode and the vibration membrane, changes thereby changing a capacitance value. The sound pressure is measured based on an electrical signal.

The piezoelectric MEMS microphone includes only a vibration membrane. When the vibration membrane is deformed by external sound pressure, an electrical signal is generated due to a piezoelectric effect. The sound pressure is measured based on the electrical signal. Significant research has been conducted to improve the sensitivity of the capacitance MEMS microphone.

The above information disclosed in this Background section is merely for enhancement of understanding of the background of the invention and therefore it may contain information that does not form the prior art that is already known in this country to a person of ordinary skill in the art.

### SUMMARY

The exemplary embodiment provides a microphone and a method of manufacturing for improving the sensitivity of the microphone.

An exemplary embodiment provides a microphone, that may include a substrate having a penetration aperture, a vibration membrane that may be disposed over the substrate and formed to cover the penetration aperture, and a fixed electrode that may be disposed over the vibration membrane, separated from the vibration membrane, and may include a plurality of air inlets. The vibration membrane may include a first sub-vibration membrane that may be disposed over the substrate and may cover the penetration aperture and include a plurality of first slots. A second sub-vibration membrane may be disposed over the first sub-vibration membrane, connected to the first sub-vibration membrane, and may include a connection unit and a plurality of second slots. The first sub-vibration membrane may be flexible, and the second sub-vibration membrane may be rigid.

The vibration membrane may include a vibration portion positioned over the penetration aperture and a fixed portion disposed over the substrate. The first slot may be disposed over the penetration aperture. The second sub-vibration membrane in the vibration portion may be connected to the first sub-vibration membrane via the connection unit. The connection unit may extend from the second sub-vibration membrane to the first sub-vibration membrane. The first sub-vibration membrane may be separated from the second sub-vibration membrane in portions other than a segment of the vibration portion in which the connection unit may be disposed.

Another aspect may include a support layer disposed over the fixed portion and positioned to support the fixed electrode. The first sub-vibration membrane and the second sub-vibration membrane may be made of polysilicon or conductive materials. The fixed electrode may be made of polysilicon or metal and the substrate may be made of silicon.

In another aspect a method of manufacturing a microphone, may include preparing a substrate and forming a first sub-vibration membrane including a plurality of first slots disposed over the substrate, and forming a first sacrificial layer through which the central portion and edge of the first sub-vibration membrane are exposed over the first sub-vibration membrane. A second sub-vibration membrane may be formed and may include a connection unit and a plurality of second slots, disposed over the first sub-vibration membrane and the first sacrificial layer. A second sacrificial layer may be formed over the second sub-vibration membrane, and a fixed electrode, including a plurality of air inlets may be formed, over the second sacrificial layer. A penetration aperture may be etched through which a portion of the first sub-vibration membrane may be exposed by etching a rear of the substrate. The first sacrificial layer and a portion of the second sacrificial layer may be removed. The first sub-vibration membrane may be flexible, and the second sub-vibration membrane may be rigid.

The connection unit may extend from a position proximate to the second sub-vibration membrane to a position proximate to the first sub-vibration membrane. The first sacrificial layer and the a portion of the second sacrificial layer may be removed and may include forming a first air layer by removing the first sacrificial layer using a wet or dry method through the first slot and may form a second air layer and a support layer supporting the fixed electrode by removing part of the second sacrificial layer using a wet or dry method through the second slot.

As described above, in accordance with an exemplary embodiment, improvements to sensitivity and signal to noise ratio of the microphone may be attributed to the vibration membrane having a flexible first sub-vibration membrane and a rigid second sub-vibration membrane. Furthermore, the noise may be reduced because the first sub-vibration membrane and the second sub-vibration membrane are connected.

### BRIEF DESCRIPTION OF THE DRAWINGS

FIG. 1 is an exemplary embodiment of a schematic cross-sectional view of a microphone in accordance with an exemplary embodiment of the present invention;

FIG. 2 is an exemplary embodiment of a top plan view schematically illustrating a first sub-vibration membrane of the microphone of FIG. 1;

FIG. 3A is an exemplary embodiment of a graph illustrating the sensitivities of the microphone in accordance with an exemplary embodiment of the present invention and a conventional microphone; FIG. 3B is an exemplary embodiment of a graph illustrating the sensitivities of the microphone in accordance with an exemplary embodiment of the present invention and a conventional microphone;

FIG. 4 is an exemplary embodiment of a diagram illustrating a method of manufacturing the microphone in accordance with an exemplary embodiment of the present invention;

FIG. 5 is an exemplary embodiment of a diagram illustrating a method of manufacturing the microphone in accordance with an exemplary embodiment of the present invention;

FIG. 6 is an exemplary embodiment of a diagram illustrating a method of manufacturing the microphone in accordance with an exemplary embodiment of the present invention;

FIG. 7 is an exemplary embodiment of a diagram illustrating a method of manufacturing the microphone in accordance with an exemplary embodiment of the present invention;

FIG. 8 is an exemplary embodiment of a diagram illustrating a method of manufacturing the microphone in accordance with an exemplary embodiment of the present invention; and

FIG. 9 is an exemplary embodiment of a diagram illustrating a method of manufacturing the microphone in accordance with an exemplary embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Hereinafter, some exemplary embodiments of the present invention are described in detail with reference to the accompanying drawing. However, the present invention is not limited to the embodiments described herein, but may be materialized in other forms. On the contrary, the introduced embodiments are provided to make disclosed contents thorough and complete and to sufficiently deliver the spirit of the present invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, In order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the drawings, the thickness of layers and areas has been enlarged for clarity of a description. Furthermore, when it is said that a layer is “on” another layer or a substrate, the layer may be directly formed on another layer or the substrate or a third layer may be interposed therebetween.

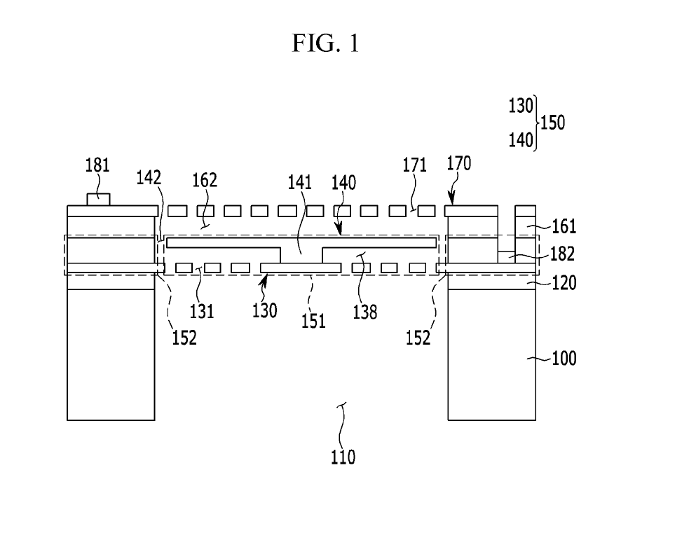

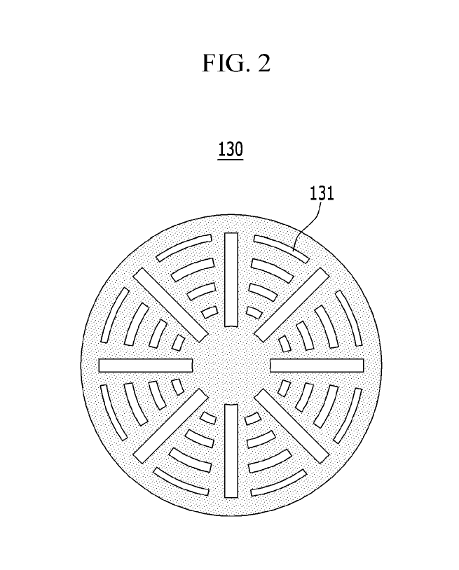

Hereinafter, a microphone in accordance with an exemplary embodiment of the present invention is described with reference to FIGS. 1 and 2. FIG. 1 is an exemplary embodiment of schematic cross-sectional view of a, and FIG. 2 is an exemplary embodiment of a top plan view schematically illustrating a first sub-vibration membrane of the microphone of FIG. 1. Referring to FIGS. 1 and 2, the microphone may include a substrate 100, a vibration membrane 150, and a fixed electrode 170. The substrate 100 may be made of silicon, and a penetration aperture 110 may be formed within the substrate 100.

The vibration membrane 150 may be disposed on the substrate 100. The vibration membrane 150 may cover (e.g., block or obstruct) the penetration aperture 110. An oxide layer 120 may be disposed between the substrate 100 and the vibration membrane 150. The vibration membrane 150 may include a vibration portion 151 and a fixed portion 152. The vibration portion 151 may cover the penetration aperture 110, and the oxide layer 120 may be disposed within the fixed portion 152. The vibration portion 151 may vibrate in response to an external sound because of the exposure of the vibration portion via the penetration aperture 110. The vibration membrane 150 may include a first sub-vibration membrane 130 and a second sub-vibration membrane 140.

The first sub-vibration membrane 130 may be disposed over the oxide layer 120, and may cover the penetration aperture 110. The first sub-vibration membrane 130 may be flexible and may include a plurality of first slots 131. The plurality of first slots 131 may be disposed within the vibration portion 151, and may have the same or varying sizes. The second sub-vibration membrane 140 may be disposed over the first sub-vibration membrane 130. The second sub-vibration membrane 140 may include a connection unit 141 that may be connected to the first sub-vibration membrane 130 and a plurality of second slots 142. The second sub-vibration membrane 140 may be rigid.

The first sub-vibration membrane 130 and the second sub-vibration membrane 140 may be in contact with each other and may be physically and electrically connected. For example, within the fixed portion 152, the second sub-vibration membrane 140 may be disposed over the first sub-vibration membrane 130. Furthermore, within the vibration portion 151, the second sub-vibration membrane 140 may be connected to the first sub-vibration membrane 130 via the connection unit 141 and may extend from a position proximate to the second sub-vibration membrane 140 toward the first sub-vibration membrane 130. Additionally, a first air layer 138 may be disposed between the first sub-vibration membrane 130 and the second sub-vibration membrane 140 within the vibration portion 151. In other words, the first sub-vibration membrane 130 and the second sub-vibration membrane 140 may be separated from each other at a predetermined interval in portions other than a segment that belongs to the vibration portion 151 and in which the connection unit 141 is disposed. The first sub-vibration membrane 130 and the second sub-vibration membrane 140 may be made of polysilicon. The present invention is not limited thereto. In some embodiments, the first sub-vibration membrane 130 and the second sub-vibration membrane 140 may be made of conductive materials.

Furthermore, the fixed electrode 170 spaced apart from the vibration membrane 150 may be disposed over the vibration membrane 150. The fixed electrode 170 may be disposed on (e.g., on the surface of) a support layer 161 and fixed thereto. The support layer 161 may be disposed at the edge portion of the second sub-vibration membrane 140 and may be configured to support the fixed electrode 170. In some embodiments, the fixed electrode 170 may be made of polysilicon or metal.

A second air layer 162 may be formed between the fixed electrode 170 and the second sub-vibration membrane 140. The fixed electrode 170 and the second sub-vibration membrane 140 may be separated from each other at a predetermined interval. Furthermore, a plurality of air inlets 171 may be disposed within the fixed electrode 170. An external sound may be introduced through the air inlets 171 that may be formed within the fixed electrode 170, thereby stimulating the vibration membrane 150. In response thereto, the vibration membrane 150 may vibrate. In other words, the sound introduced through the air inlets 171 may stimulate the first sub-vibration membrane 130 through the second slots 142 of the second sub-vibration membrane 140. In response to the simulation, the flexible first sub-vibration membrane 130 may vibrate. When the first sub-vibration membrane 130 vibrates, the second sub-vibration membrane 140 connected to the first sub-vibration membrane 130 may also vibrate. Furthermore, a sound may be introduced through the penetration aperture 110, and the sound may directly stimulate the first sub-vibration membrane 130.

In particular, the vibration membrane 150 may vibrate in response to the external sound, and the distance between the second sub-vibration membrane 140 and the fixed electrode 170 may change Additionally, the capacitance between the second sub-vibration membrane 140 and the fixed electrode 170 may also change. A signal processing circuit (not shown) may convert the changed capacitance into an electrical signal through a first pad 181 that may be connected to the fixed electrode 170 and a second pad 182 connected to the vibration membrane 150, thereby detecting the external sound.

Typically, a conventional microphone may include only a flexible vibration membrane. When the vibration membrane vibrates, the distance between the fixed electrode and the vibration membrane may vary. However, the microphone according to the present exemplary embodiment has a vibration membrane 150 that includes the flexible first sub-vibration membrane 130 and the rigid second sub-vibration membrane 140. For example, the first sub-vibration membrane 130 may vibrate; the second sub-vibration membrane 140 may be displaced in the vertical and/or lateral directions because the first sub-vibration membrane 130 and the second sub-vibration membrane 140 may be connected. Further, the distance between the fixed electrode 170 and the second sub-vibration membrane 140 may remain uniform because the second sub-vibration membrane 140 may be rigid. Additionally, the sensitivity and signal to noise ratio of the microphone may be improved.

Moreover, a method of packaging a microphone may include a top port method of disposing an aperture at the top and a bottom port method of disposing an aperture at the bottom. A signal to noise ratio of a microphone of the bottom port method of directly transferring sound pressure to the vibration membrane may provide improved performance compared to that of a microphone of the top port method. In the present exemplary embodiment, the first sub-vibration membrane 130 having flexibility may be disposed under the second sub-vibration membrane 140 having rigidity. The microphone according to the present exemplary embodiment may be packaged using the bottom port method, external sound pressure may be directly transferred to the first sub-vibration membrane 130 through the penetration aperture 110 and therefore the loss of sound pressure may be minimized. Additionally, performance of the microphone may be improved. Furthermore, the generation of noise may be reduced because the first sub-vibration membrane 130 and the second sub-vibration membrane 140 are connected.

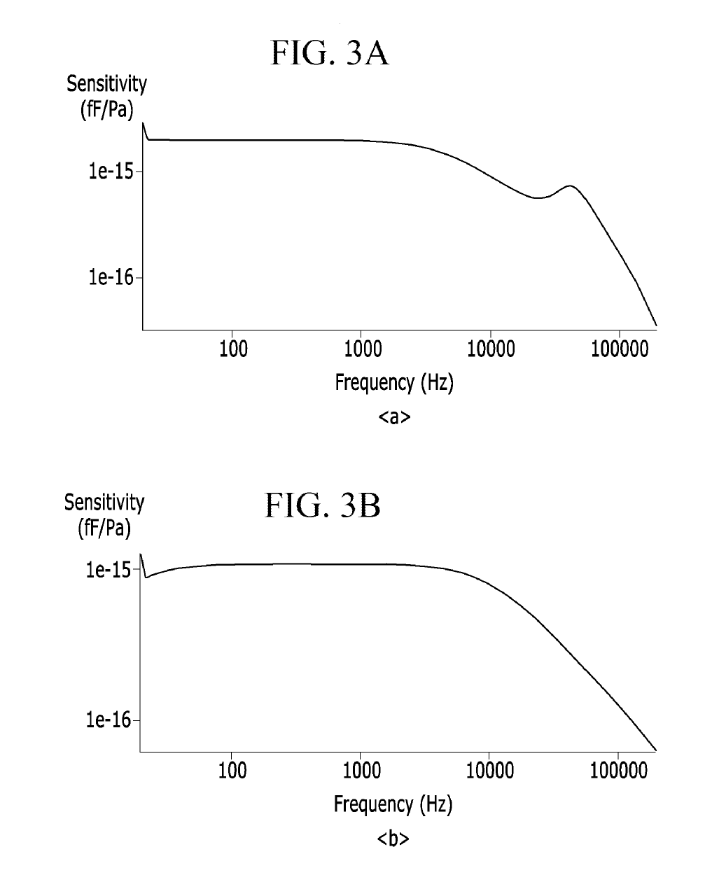

The sensitivity characteristics of the microphone in accordance with an exemplary embodiment and the conventional microphone are described below with reference to FIGS. 3A and 3B. FIG. 3 is an exemplary embodiment of a graph illustrating the sensitivities of the microphone in accordance with an exemplary embodiment of the present invention and a conventional microphone. FIG. 3A is an exemplary embodiment of a graph illustrating the sensitivity of the microphone in accordance with an exemplary embodiment of the present invention, and FIG. 3B is an exemplary embodiment of a graph illustrating the sensitivity of the conventional microphone.

In FIGS. 3A and 3B, the vibration membrane of the microphone according to the present exemplary embodiment may configured to include the first sub-vibration membrane and the second sub-vibration membrane, and the vibration membrane of the conventional microphone may be configured to include a single vibration membrane. In some embodiments, the first sub-vibration membrane and second sub-vibration membrane of the microphone according to the present exemplary embodiment and the vibration membrane of the conventional microphone may be made of polysilicon. FIGS. 3A and 3B illustrate that the microphone according to the present exemplary embodiment may have a sensitivity (fF/Pa) of 1.95 at 1 KHz, and the conventional microphone may have a sensitivity (fF/Pa) of 1 at 1 KHz. In other words, the sensitivity of the microphone according to the present exemplary embodiment may be about two times better than that of the conventional microphone.

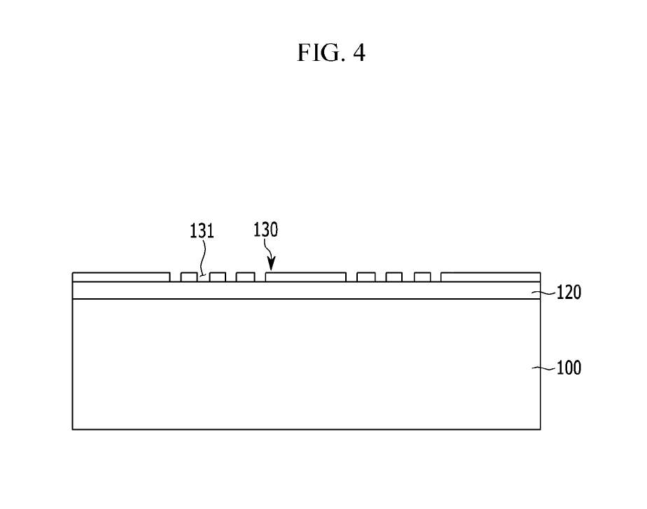

A method of manufacturing the microphone in accordance with an exemplary embodiment is described below with reference to FIGS. 4 to 9 and 1. FIGS. 4 to 9 are exemplary diagrams illustrating a method of manufacturing the microphone in accordance with an exemplary embodiment of the present invention. Referring to FIG. 4, after the substrate 100 may be prepared, the oxide layer 120 may be formed on the substrate 100. The first sub-vibration membrane 130 may include the plurality of first slots 131 that may be formed on the oxide layer 120. In some embodiments, the substrate 100 may be made of silicon, and the first sub-vibration membrane 130 may be made of polysilicon or conductive materials. Furthermore, the first sub-vibration membrane 130 may be flexible.

The first sub-vibration membrane 130 including the plurality of first slots 131 may be formed by forming a polysilicon layer or conductive material layer disposed on the oxide layer 120 and patterning the polysilicon layer or conductive material layer. In particular, the polysilicon layer may be patterned or the material layer may be performed by forming a photoresist layer on the polysilicon layer or conductive material layer. Further a photoresist layer pattern may be formed by performing exposure and development on the photoresist layer, and etching the polysilicon layer or conductive material layer using the photoresist layer pattern as a mask.

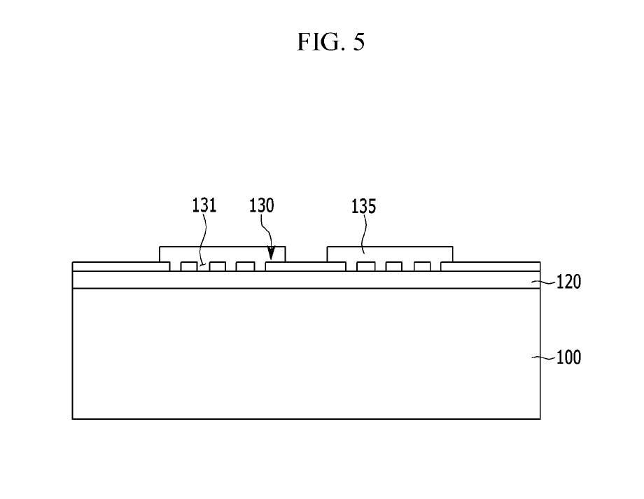

Referring to FIG. 5, a first sacrificial layer 135 may be formed on the first sub-vibration membrane 130. The first sacrificial layer 135 may be made of photoresist materials, silicon oxide, or silicon nitride. The first sacrificial layer 135 may be formed by forming a photoresist material layer, a silicon oxide layer, or a silicon nitride layer on the first sub-vibration membrane 130 and patterning the photoresist material layer, the silicon oxide layer, or the silicon nitride layer. The first sacrificial layer 135 may be disposed over the first slots 131 of the first sub-vibration membrane 130, however, the central portion and edge portions of the first sub-vibration membrane 130 may be exposed through the first sacrificial layer 135.

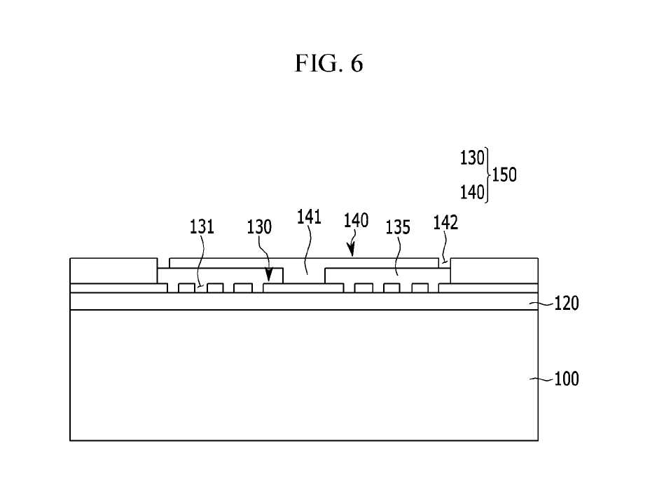

Referring to FIG. 6, the second sub-vibration membrane 140 including the connection unit 141 and the plurality of second slots 142 may be formed on the first sub-vibration membrane 130 and the first sacrificial layer 135. The second sub-vibration membrane 140 may be made of polysilicon or conductive materials. Furthermore, the second sub-vibration membrane 140 may be rigid. The second sub-vibration membrane 140 may include the connection unit 141 and the plurality of second slots 142 may be formed by forming a polysilicon layer or conductive material layer on the first sub-vibration membrane 130 and the first sacrificial layer 135 and patterning the polysilicon layer or conductive material layer. In some embodiments, the patterning of the polysilicon layer or conductive material layer may be performed by forming a photoresist layer on the polysilicon layer or conductive material layer. Further, a photoresist layer pattern may be formed by performing exposure and development on the photoresist layer, and the polysilicon layer or conductive material layer may be etched using the photoresist layer pattern as a mask.

The second sub-vibration membrane 140 may be disposed over the first sub-vibration membrane 130 at the edge portion of the first sub-vibration membrane 130 and may be connected to the first sub-vibration membrane 130 through the connection unit 141 at the central portion of the first sub-vibration membrane 130. The connection unit 141 may extend from the second sub-vibration membrane 140 toward the first sub-vibration membrane 130. Accordingly, the vibration membrane 150 including the first sub-vibration membrane 130 and the second sub-vibration membrane 140 may be formed.

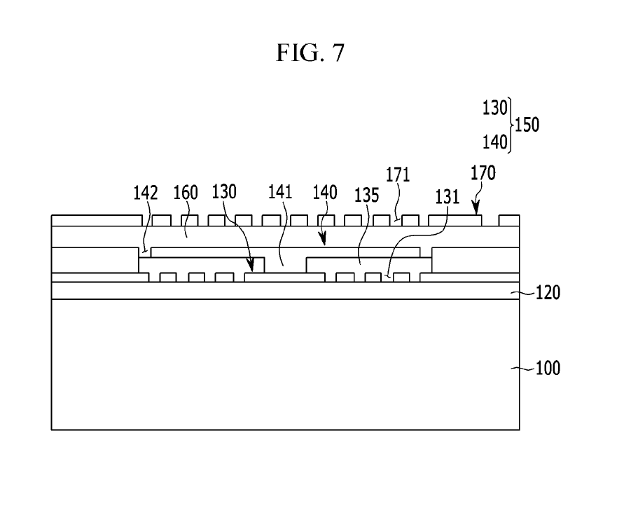

Referring to FIG. 7, after a second sacrificial layer 160 is formed on the second sub-vibration membrane 140, the fixed electrode 170 including the plurality of the air inlets 171 may be formed on the second sacrificial layer 160. The second sacrificial layer 160 may be made of photoresist materials, silicon oxide, or silicon nitride. The fixed electrode 170 may be made of polysilicon or metal. The fixed electrode 170 may include the plurality of the air inlets 171 and may be formed by forming a polysilicon layer or a metal layer on the second sacrificial layer 160 and patterning the polysilicon layer or the metal layer. In some embodiments, the polysilicon layer or the metal layer may be patterned by forming a photoresist layer on the polysilicon layer or the metal layer. Further, a photoresist layer pattern may be formed by performing exposure and development on the photoresist layer, and the polysilicon layer or the metal layer may be etched using the photoresist layer pattern as a mask.

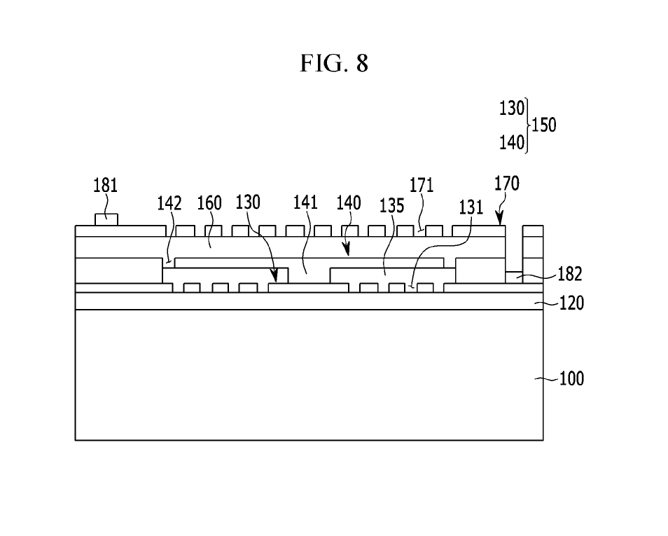

Referring to FIG. 8, the first pad 181 connected to the fixed electrode 170 and the second pad 182 connected to the vibration membrane 150 may be formed. The first pad 181 may be formed on the fixed electrode 170. The second pad 182 may be formed on the first sub-vibration membrane 130 by simultaneously etching part of the second sacrificial layer 160 and part of the second sub-vibration membrane 140.

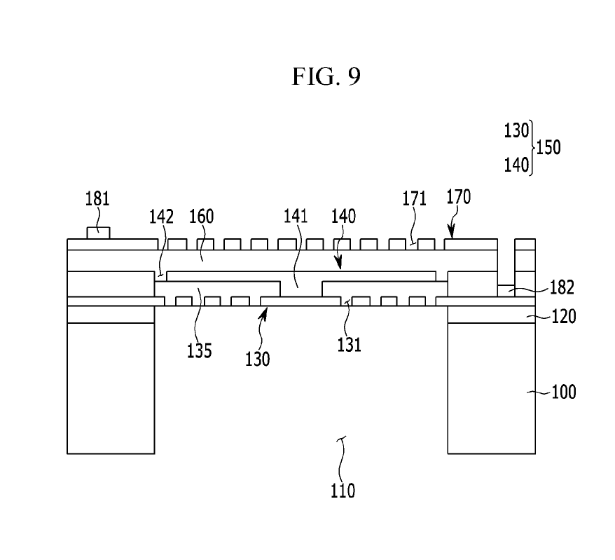

Referring to FIG. 9, the penetration aperture 110 may be formed on the substrate 100. The penetration aperture 110 may be formed by performing dry etching or wet etching on the rear of the substrate 100. For example, when the rear of the substrate 100 is etched, a portion of the oxide layer 120 may be exposed, thereby exposing a portion of the first sub-vibration membrane 130.

Referring to FIG. 1, the first air layer 138 may be formed by removing the first sacrificial layer 135. Furthermore, the second air layer 162 and the support layer 161 may be formed by removing part of the second sacrificial layer 160. In particular, the vibration membrane 150 may include the vibration portion 151 and the fixed portion 152. The fixed portion 152 may be placed between the oxide layer 120 and the support layer 161. The vibration portion 151 may be placed between the penetration aperture 110 and the second air layer 162.

The first sacrificial layer 135 may be removed by a wet method that may use an etchant through the first slots 131 of the first sub-vibration membrane 130. Furthermore, the first sacrificial layer 135 may be removed using a dry method, such as ashing according to O₂ plasma, through the first slots 131 of the first sub-vibration membrane 130.

The second sacrificial layer 160 may be removed by a wet method that may use an etchant through the air inlets 171. Furthermore, the second sacrificial layer 160 may be removed using a method, such as ashing according to O₂ plasma, through the air inlets 171. When a portion of the second sacrificial layer 160 is removed by the wet or dry method, the second air layer 162 may be formed between the fixed electrode 170 and the second sub-vibration membrane 140. The second sacrificial layer 160 that remains intact may form the support layer 161 supporting the fixed electrode 170. The support layer 161 may be formed on the second sub-vibration membrane 140 of the fixed portion 152.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims. In addition, it is to be considered that all of these modifications and alterations fall within the scope of the present invention.

### DESCRIPTION OF SYMBOLS

110: substrate

110: penetration aperture

130: first sub-vibration membrane

131: first slot

135: first air layer

140: second sub-vibration membrane

141: connection unit

142: second slot

150: vibration membrane

151: vibration portion

152: fixed portion

160: second sacrificial layer

161: support layer

162: second air layer

170: fixed electrode

171: air inlet

What is claimed is:

1. A microphone, comprising:
a substrate including a penetration aperture;
a vibration membrane disposed over the substrate and covering the penetration aperture; and
a fixed electrode disposed over the vibration membrane, separated from the vibration membrane, and having a plurality of air inlets,
wherein the vibration membrane includes:
a first sub-vibration membrane disposed over the substrate and covering the penetration aperture and having a plurality of first slots, and
a second sub-vibration membrane disposed over the first sub-vibration membrane, connected to the first sub-vibration membrane, and having a connection unit and a plurality of second slots,
wherein, the first sub-vibration membrane has flexibility, and the second sub-vibration membrane has rigidity.

2. The microphone of claim 1, wherein the vibration membrane includes a vibration portion disposed over the penetration aperture and a fixed portion disposed over the substrate.

3. The microphone of claim 2, wherein the first slot is disposed over the penetration aperture.

4. The microphone of claim 3, wherein the second sub-vibration membrane within the vibration portion is connected to the first sub-vibration membrane via the connection unit.

5. The microphone of claim 4, wherein the connection unit protrudes from the second sub-vibration membrane to the first sub-vibration membrane.

6. The microphone of claim 5, wherein the first sub-vibration membrane is separated from the second sub-vibration membrane in a portion other than a portion of the vibration portion in which the connection unit is disposed.

7. The microphone of claim 2, further comprising a support layer disposed over the fixed portion and supporting the fixed electrode.

8. The microphone of claim 1, wherein the first sub-vibration membrane and the second sub-vibration membrane are made of a polysilicon material or a conductive material.

9. The microphone of claim 8, wherein the fixed electrode is made of polysilicon or metal.

10. The microphone of claim 9, wherein the substrate is made of silicon.

11. A method of manufacturing a microphone, comprising:
preparing a substrate and forming a first sub-vibration membrane having a plurality of first slots disposed over the substrate;
forming a first sacrificial layer through which a central portion and edge of the first sub-vibration membrane are exposed over the first sub-vibration membrane;
forming a second sub-vibration membrane, having a connection unit and a plurality of second slots, disposed over the first sub-vibration membrane and the first sacrificial layer;
forming a second sacrificial layer over the second sub-vibration membrane;
forming a fixed electrode, having a plurality of air inlets, disposed over the second sacrificial layer;
etching a penetration aperture through which a portion of the first sub-vibration membrane is exposed by etching a rear of the substrate; and
removing the first sacrificial layer and removing a portion of the second sacrificial layer,
wherein the first sub-vibration membrane has flexibility, and the second sub-vibration membrane has rigidity.

12. The method of claim 11, wherein the connection unit extends in a direction from the second sub-vibration membrane toward the first sub-vibration membrane.

13. The method of claim 12, wherein the connection unit is connected to a central portion of the first sub-vibration membrane.

14. The method of claim 13, wherein the first slot is disposed over the penetration aperture.

15. The method of claim 14, wherein removing the first sacrificial layer and removing the portion of the second sacrificial layer includes:
forming a first air layer by removing the first sacrificial layer using a wet or dry method through the first slot, and
forming a second air layer and a support layer supporting the fixed electrode by removing the portion of the second sacrificial layer using a wet or dry method through the second slot.

16. The method of claim 11, wherein the first sub-vibration membrane and the second sub-vibration membrane are made of a polysilicon material or a conductive material.

17. The method of claim 16, wherein the fixed electrode is made of polysilicon or metal.

18. The method of claim 17, wherein the substrate is made of silicon.
